(19) United States
(12) Patent Application Publication
(10) Pub. No.: US 2024/0097106 A1
(43) Pub. Date: Mar. 21, 2024

(54) BATTERY ELECTRODE MANUFACTURING DEVICE AND METHOD OF MANUFACTURING BATTERY ELECTRODE

(71) Applicant: APB CORPORATION, Fukui (JP)

(72) Inventors: Hideaki HORIE, Fukui (JP); Kenichiro ENOKI, Kyoto (JP); Yusuke NAKASHIMA, Kyoto (JP)

(21) Appl. No.: 18/255,093

(22) PCT Filed: Nov. 30, 2021
(86) PCT No.: PCT/JP2021/043728

§ 371 Date: May 30, 2023

(30) Foreign Application Priority Data
Nov. 30, 2020 (JP) 2020-199039

(51) Int. Cl. H01M 4/139; H01M 4/04; H01M 10/04

(52) U.S. Cl. CPC H01M 4/139; H01M 4/043; H01M 10/0404

(57) ABSTRACT

A battery electrode manufacturing device, which can suppress air from being contained in the active material and improve uniformity of an active material layer formed on a current collector, is provided. The battery electrode manufacturing device comprises: a first chamber whose interior is decompressed below atmospheric pressure; an active material supply unit that supplies a powdery active material onto a current collector, which is arranged in the first chamber; and a compressor that compresses the active material supplied on the current collector, wherein the active material supply unit and the compressor are arranged in the first chamber.

### FIELD OF THE INVENTION

This invention relates to a battery electrode manufacturing device and a method of manufacturing a battery electrode.

### BACKGROUND ART

In general, the lithium-ion battery is composed of a cathode that has a cathode active material layer formed on a cathode current collector, and an anode that has an anode active material layer formed on an anode current collector, wherein the cathode and the anode are stacked via a separator. In a case when manufacturing this electrode for a lithium-ion battery, for example, as described in Patent Reference 1, after an active material is supplied onto a current collector, the active material is compressed.

### CITATION LIST

### Patent Literature

[Patent Reference 1] Publication of Japanese Patent No. 6633866

### BRIEF SUMMARY OF THE INVENTION

### Problems that Invention is to Solve

However, in Patent Reference 1, the active material is supplied onto the current collector and then compressed in the atmosphere. If the active material is supplied onto the current collector in the atmosphere, an active material layer containing the air may be formed on the current collector. Then, in a case when the active material layer formed on the current collector is compressed in the atmosphere, the active material layer is compressed while the air remains in the active material. Therefore, the air may expand after the compression. As a result, problems such as the active material popping or unevenness formed on the surface of the active material may occur. The electrodes used in lithium-ion batteries exhibit stable battery performance by forming a homogeneous active material layer containing the active material supplied on the current collector. However, with the conventional configuration, it may be difficult to suppress the above-described problems, and there is a possibility that the desired battery performance cannot be obtained.

The present invention has been made in view of the above-mentioned problems and has an objective to provide a battery electrode manufacturing device and a method of manufacturing a battery electrode, which are operable to improve uniformity of an active material layer formed on a current collector.

### Means to Solve the Problems

A battery electrode manufacturing device according to one variation of this invention, wherein the battery electrode manufacturing device comprising: a first chamber whose interior is decompressed below atmospheric pressure; an active material supply unit that supplies a powdery active material onto a current collector, which is arranged in the first chamber; and a compressor that compresses the active material supplied on the current collector, wherein the active material supply unit and the compressor are arranged in the first chamber.

A method of manufacturing a battery electrode according to one variation of this invention, wherein the method comprising: a supply step of supplying a powdery active material onto a current collector, which is arranged in a first chamber whose interior is decompressed below atmospheric pressure; and a compressing step of compressing the active material supplied on the current collector, wherein the supply step and the compressing step are conducted in the first chamber.

### Effects of the Invention

According to the battery electrode manufacturing device and the method of manufacturing a battery electrode of this invention, it is possible to suppress air from being contained in the active material in a case when the active material is compressed. Also, it is possible to improve uniformity of an active material layer formed on a current collector.

### BRIEF DESCRIPTION OF DRAWINGS

FIG. 1 is a cross-sectional view schematically showing a battery manufactured by a battery electrode manufacturing device of an embodiment.

FIG. 2 is a cross-sectional view schematically showing the single cell of the battery.

FIG. 3 is a perspective view of the partially fractured battery electrode manufacturing apparatus of the embodiment.

FIG. 4 is a perspective view of a frame member supply device constituting the battery electrode manufacturing device.

FIG. 5 is a partially broken perspective view of the active material supply device and the second compress device constituting the battery electrode manufacturing device.

### DESCRIPTION OF EMBODIMENTS

Hereinafter, the first embodiment of the present invention will be explained by referring to the figures. Herein, in the figures used in the following explanations, some characteristic parts may be enlarged for the purpose of emphasizing said characteristic parts. Therefore, the dimensional ratios and the like of each component are not necessarily the same as the real ones. In addition, for the same purpose, some non-characteristic parts may be omitted from the figures.

### <Battery (Secondary Battery)>

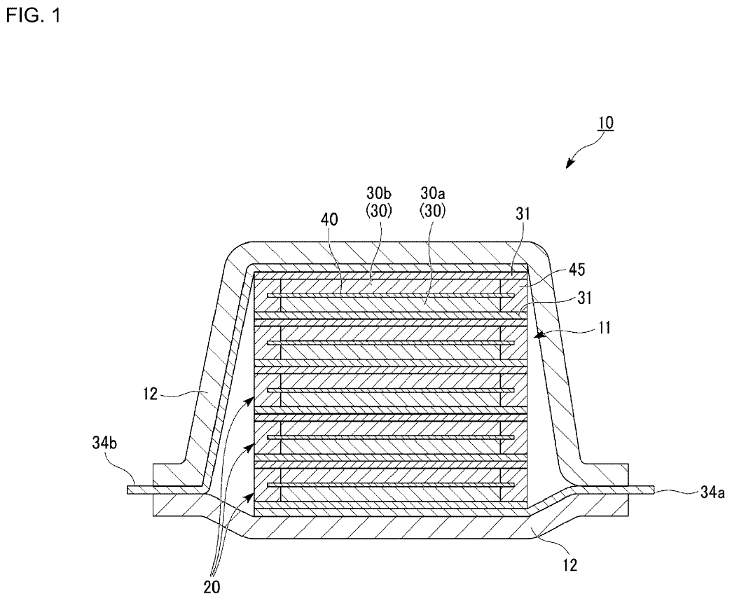

FIG. 1 is a cross-sectional view schematically showing a battery 10 manufactured using a battery electrode manufacturing device (hereinafter abbreviated as manufacturing device) of the first embodiment. The battery (secondary battery) 10 of this embodiment is a lithium-ion secondary battery, which is a type of non-aqueous electrolyte secondary battery. Herein, a lithium-ion battery (single battery unit) in this specification refers to a secondary battery that uses lithium ions as charge carriers and is charged and discharged by the movement of lithium ions between the cathode and the anode. The lithium-ion battery (secondary battery) includes a battery using a liquid material for the electrolyte and a battery (so-called all-solid battery) using a solid material for the electrolyte. The lithium-ion battery of this embodiment includes a battery that has a metal foil (metal current collector foil) as a current collector. Also, the lithium-ion battery of this embodiment includes a battery that has so-called resin current collectors, and that are composed of a resin onto which a conductive material is added instead of the metal foil. In a case when such a resin current collector is used as, for example, a resin current collector for a bipolar electrode, a cathode may be formed on one surface of the resin current collector, and an anode may be formed on the other surface of the resin current collector so as to form a bipolar electrode. Furthermore, the lithium-ion battery of this embodiment includes an electrode in which a cathode active material or an anode active material is respectively applied onto the cathode current collector or the anode current collector using a binder. In the case of a bipolar battery, it also includes a bipolar electrode in which one surface of the current collector is coated with a cathode active material using a binder to form a cathode layer, and the other surface is coated with an anode active material using a binder to form an anode layer. Hereinafter, in a case when a cathode 30a and an anode 30b are referred to without distinction, they are referred to as an electrode 30.

The battery 10 can also be applied to any conventional secondary battery such as a so-called parallel stacked battery in which electrodes are connected in parallel in terms of a power generation element. Herein, the lithium-ion secondary battery is simply called “battery” in the following explanation.

The battery 10 of this embodiment comprises a power generation element 11, a cathode tab 34a, an anode tab 34b, and an exterior body 12.

The cathode tab 34a contacts the end surface of the cathode side of the power generation element 11. Similarly, the anode tab 34b contacts the end surface of the anode side of the power generation element 11. The cathode tab 34a and the anode tab 34b are pulled out of the exterior body 12, respectively. A highly conductive material such as aluminum, copper alloy or the like, is used for the cathode tab 34a and the anode tab 34b.

In order to avoid an impact or an environmental deterioration from the outside, the exterior body 12 seals the power generation element 11 inside. For example, the exterior body 12 is configured in a bag shape with a laminated film. A metal can case or the like may be used for the exterior body 12.

The power generation element 11 of the battery 10 of this embodiment comprises a plurality of single cells (battery cells) 20. In the power generation element 11, the plurality of single cells 20 are stacked along the thickness direction. The number of stacked unit cells 20 is adjusted according to the desired voltage. A method of stacking the unit cells 20 in the power generation element 11 is arbitrary. For example, the power generation element 11 may be a stacked battery in which a plurality of adjacent single cells 20 are stacked in series such that a first surface and a second surface of the pair of unit cells 20 are adjacent to each other, wherein the unit cell 20 has a cathode resin current collector on the first surface and an anode resin current collector on the second surface. For another example, the power generation element 11 may be a stacked battery in which a plurality of single cells 20 are stacked via an electrolyte layer, wherein the unit cell 20 comprises a cathode layer provided on one side of a single resin current collector and an anode layer provided on the other side of the resin current collector.

### <Single Cell (Battery Cell)>

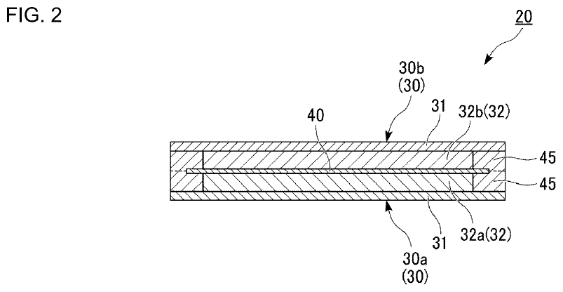

FIG. 2 is a cross-sectional view schematically showing the single cell 20. The single cell 20 comprises a cathode 30a and an anode 30b as two electrodes (battery electrodes) and a separator 40.

The separator 40 is arranged between the cathode 30a and the anode 30b. As for the power generation element 11, the plurality of single cells 20 are stacked while the cathode 30a and the anode 30b are directed in the same direction. As for the power generation element 11, the cathode tab 34a is in contact with the cathode 30a of the single cell 20 arranged at the end of the cathode side along the stacking direction, and the anode tab 34b is in contact with the anode 30b of the single cell 20 arranged at the end of the anode side along the stacking direction.

The separator 40 holds an electrolyte. Due to this, the separator 40 functions as an electrolyte layer. The separator 40 is arranged between the electrode active material layers 32 of the cathode 30a and the anode 30b. As a result, the separator 40 can prevent the electrode active material layers 32 from being in contact with each other. Therefore, the separator 40 functions as a partition wall between the cathode 30a and the anode 30b.

The electrolyte contained in the separator 40 includes, for example, an electrolytic solution or a gel polymer electrolyte. By using these electrolytes, high lithium-ion conductivity is ensured. Examples of the form of the separator include porous sheet separators and non-woven fabric separators made of a polymer or fiber that absorbs and retains the electrolyte. A sulfide-based or oxide-based inorganic solid electrolyte or a polymer-based organic solid electrolyte can be used as the separator. By applying the solid electrolyte, an all-solid battery can be constituted.

Each of the cathode 30a and the anode 30b has a current collector 31, an electrode active material layer 32, and a frame member 45. The electrode active material layer 32 and the current collector 31 are arranged in this order from the side of the separator 40. The frame member 45 is frame-shaped (circular). The frame member 45 surrounds the electrode active material layer 32. The frame member 45 of the cathode 30a and the frame member 45 of the anode 30b are welded and integrated with one another.

In the following description, in a case when distinguishing the electrode material layers 32 between the cathode 30a and the anode 30b, they are referred to as a cathode active material layer 32a and an anode active material layer 32b, respectively.

The frame member 45 prevents contact between the current collectors 31 and short-circuiting at the end of the single cell 20. As a material of the frame member 45, any material with insulating properties, sealing properties (liquid-tightness), heat resistance under a battery operating temperature, and the like, may be used. A resin material is preferably chosen.

The current collector 31 is a conductive sheet-shaped member. The material constituting the current collector 31 is not particularly limited, but for example, conductive resin or metal can be used. Based on the viewpoint of weight reduction, the current collector 31 is preferably a resin current collector made of a conductive resin. Herein, from the viewpoint of blocking the lithium-ion movement between the single cells 20, a metal layer may be formed in the part of the resin current collector 31.

Examples of the conductive resin constituting the resin current collector 31 include a resin obtained by adding a conductive filler to a conductive polymer material or a non-conductive polymer material when necessary.

The electrode active material layer 32 comprises electrode granulated particles (hereinafter simply granulated particles) containing an electrode active material (cathode active material or anode active material) and a conductive auxiliary agent. In addition, the electrode active material layer 32 may further comprise either one or both of an electrolytic solution and an adhesive, if needed. Furthermore, the electrode active material layer 32 may contain an ion-conductive polymer or the like, if necessary. In the following description, when distinguishing the electrode active materials between the cathode active material layer 32a and the anode active material layer 32b, they are called a cathode active material and an anode active material, respectively.

### <Manufacturing Device and Battery Electrode Manufacturing Method>

Next, a manufacturing device and a battery electrode manufacturing method (hereinafter abbreviated as manufacturing method) will be explained. In the battery manufacturing device and the manufacturing method, the cathode 30a and the anode 30b are first manufactured. The manufacturing method of the cathode 30a and the manufacturing method of the anode 30b mainly differ in terms of the electrode active material contained in the electrode active material layer 32. Herein, as a manufacturing method of the electrode 30, a manufacturing method of the cathode 30a and the anode 30b will be described at the same time.

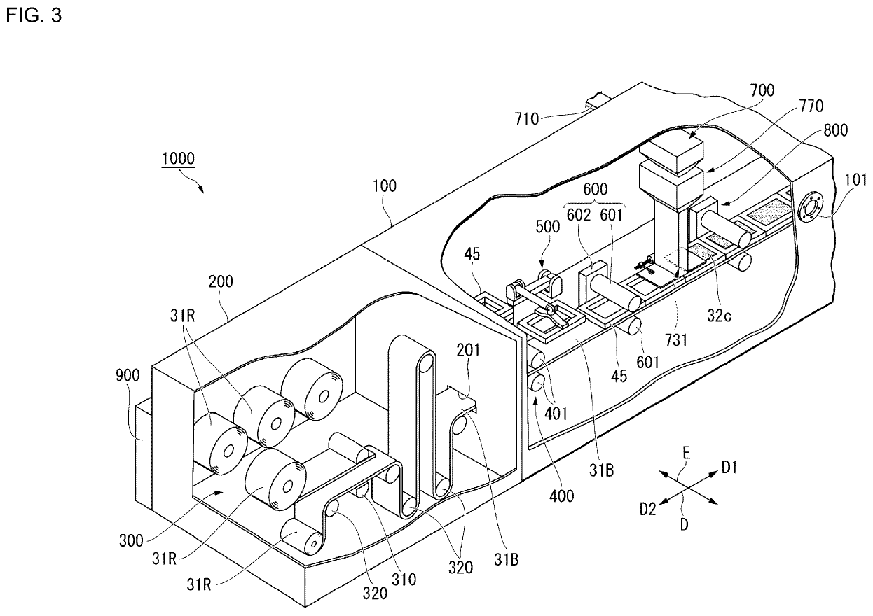

FIG. 3 is a perspective view of the manufacturing device 1000. The manufacturing device 1000 comprises a first chamber (chamber) 100, a second chamber 200, a current collector supply device (current collector supply unit) 300, a conveying device 400, and a frame member supply device (frame member supply unit) 500, a first roll press 600, an active material supply device 700, a second roll press (compression unit) 800, and a control unit 900.

The first chamber 100 and the second chamber 200 are rooms whose interior is decompressed and maintained below atmospheric pressure. An observation window (viewing port) 101, that is a window made of pressure-resistant glass, is provided with the side wall of the first chamber 100. Thus, the inside of the first chamber 100 can be observed through the observation window 101 from the outside of the first chamber 100. The pressure inside the first chamber 100 is decompressed below atmospheric pressure by a first decompress pump (not shown). The pressure inside the first chamber 100 may be any value as long as it is decompressed below the atmospheric pressure. However, for example, it may be adjusted to be a low vacuum environment from atmospheric pressure to 1×10⁻¹ to 1×10⁻² Pa, or a high vacuum environment from 1×10⁻⁶ to 1×10⁻⁷ Pa, or an ultra-high vacuum more than that, or an extremely high vacuum of 10⁻⁸ to 10⁻⁹ Pa level. The standard atmospheric pressure is approximately 1013 hPa (approximately 10⁵ Pa). The pressure inside the second chamber 200 is decompressed below atmospheric pressure by a second decompress pump (not shown). The pressure inside the second chamber 200 may be any value as long as it is decompressed below the atmospheric pressure. However, for example, it may be adjusted to be a low vacuum environment from atmospheric pressure to 1×10⁻¹ to 1×10⁻² Pa, or a high vacuum environment from 1×10⁻⁶ to 1×10⁻⁷ Pa, or an ultra-high vacuum more than that, or an extremely high vacuum of 10⁻⁸ to 10⁻⁹ Pa level. The pressure inside the second chamber 200 may be higher than the pressure inside the first chamber 100.

The first chamber 100 and the second chamber 200 are arranged side by side along the conveying direction D in which the current collector supply device 300 conveys the strip-shaped current collector 31B. The current collector 31B is in a pre-state where the current collector 31 is cut into a predetermined shape. The first chamber 100 is arranged downstream side D1 along the conveying direction D from the second chamber 200. The second chamber 200 is the antechamber. A slit 201 is formed in the downstream side D1 wall of the second chamber 200. A slit (not shown in the figure) is formed in the upstream D2 side wall of the second chamber 200, wherein the upstream side D2 is opposite from the downstream side D1. This slit is formed to face the slit 201 of the second chamber 200.

The current collector supply device 300 is arranged in the second chamber 200. In the first chamber 100, a conveying device 400, a frame member supply device 500, a first roll press 600, an active material supply device 700, and a second roll press 800 are provided.

The current collector supply device 300 supplies the current collector 31B into the first chamber 100. The current collector supply device 300 comprises a roll holder (not shown in the figure), a splicer 310, and a feed roller 320. A pair of current collector rolls 31R are held in the roll holder. The current collector roll 31R is obtained by rolling the current collector 31B. The current collector roll 31R is unfolded as appropriate, and the current collector 31B is supplied from the current collector roll 31R. In a case when one of the pair of current collector rolls 31R is completely unfolded, the roll holder starts supplying the other of the pair of current collector rolls 31R.

The splicer 310 bonds the ends of the current collectors 31B. In a case when one current collector roll 31R is completely unfolded and all of the current collectors 31B are supplied, finally, the terminal end of the current collector 31B moves toward the downstream side D1. The splicer 310 bonds this terminal end with the starting end of the current collector 31B, where this starting end is developed from the other current collector roll 31R. With this configuration, the plurality of current collectors 31B are continuously supplied into the first chamber 100 without interruption.

The feed roller 320 is provided in the downstream side D1 of the roll holder. The feed roller 320 is composed of a plurality of rotating members. The current collector 31B conveyed by the feed roller 320 moves along the plurality of rotating members. Due to this, the current collector 31B is stably supplied into the first chamber 100 in the downstream side D1 without the current collector 31B being loosened in the middle of the feed roller 320. The current collector supply device 300 supplies the current collector 31B at a predetermined speed. A spare current collector roll 31R is preferably arranged inside the second chamber 200. The current collector 31B supplied from the current collector supply device 300 to the downstream side D1 is supplied into the second chamber 200 through the slit 201 of the second chamber 200 and the slit of the first chamber 100.

In this embodiment, the entire current collector supply device 300 is arranged in the second chamber 200. It is noted that the roll holder and the like of the current collector supply device 300 may be arranged outside the second chamber 200. In this case, part of the current collector supply device 300 is arranged in the second chamber 200.

For example, the conveying device 400 is a known belt conveyor. The conveying device 400 includes conveying rollers 401. The conveying roller 401 is arranged such that its rotation axis extends both along the horizontal plane and along the width direction E, which is orthogonal to the conveying direction D. The conveying device 400 conveys the current collector 31B to the downstream side D1 at a predetermined speed in the first chamber 100. The current collector 31B is conveyed in the first chamber 100. The frame member supply device 500, the first roll press 600, the active material supply device 700, and the second roll press 800 are arranged side by side in this order from the upstream side D2 to the downstream side D1 along the conveying device 400.

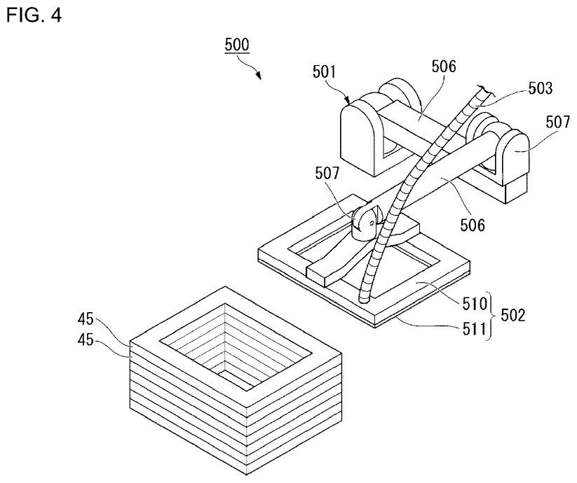

FIG. 4 is a perspective view of the frame member supply device 500. The frame member supply device 500 is placed in the upstream side D2 from the active material supply device 700. The frame member supply device 500 supplies the frame member 45, which is stacked on the side of the conveying device 400 and is placed in the second chamber 200 onto the current collector 31B. The frame member supply device 500 has a robot arm 501, a holder 502, and a degassing pipe 503. The robot arm 501 has a known configuration wherein a plurality of rods 506 are connected with joints 507. A base end of the robot arm 501 is fixed to the floor of the first chamber 100 or the like.

The holder 502 is frame-shaped and has the same size as the frame member 45. For example, the holder 502 comprises a body part 510, an elastic part 511, and a suction cup part (not shown in the figure). The body part 510 is a member having a cross-section that is U-shaped with an opening on the lower surface side. Further, the opening of the body part 510 has a frame shape that matches the shape of the frame member 45. The elastic part 511 is provided so as to close the opening of the body part 510. The elastic part 511 is a part placed on the body part 510 and is in contact with the frame member 45. Herein, in order to adsorb the frame member 45 onto the adsorption part, the elastic part 511 needs to be in close contact with the frame member 45 without any gap. The suction cup part is a thin part of the elastic part 511. A plurality of suction cup parts is provided on the surface of the elastic portion 511 while leaving a space wherein the surface is in contact with the frame member 45. In the present embodiment, the suction cup parts are flat on the surface side of the elastic part 511, wherein the surface side is in contact with the frame member 45. The suction cup part has a recess on the surface side of the body part 510.

The internal space at the first end of the degassing pipe 503 links to the internal space of the body part 510. A decompression pump (not shown in the figure) is connected to a second end of the degassing pipe 503, wherein the second end is opposite from the first end. The decompression pump is equipped with a valve for switching whether to discharge the air in the internal space of the degassing pipe 503 connected to the decompression pump. The decompression pump is preferably arranged outside the second chamber 200.

As for the frame member supply device 500 configured as described above, the decompression pump is driven while the elastic part 511 is in close contact with the frame member 45, and the valve is switched so that the air in the internal space of the degassing pipe 503 is discharged. Then, the air inside the holder 502 is discharged to the outside of the second chamber 200 through the degassing pipe 503 and the decompression pump. The air pressure inside the holder 502 is reduced. As a result, a force that sucks the elastic part 511 toward the inside of the body part 510 is generated. In a case when this force is generated, firstly, the suction cup part moves inward of the body part 510.

Then, a force acts to create a gap between the frame member 45 and the suction cup part. On the other hand, the elastic part 511 remains in contact with the frame member 45. The gap generated between the frame member 45 and the suction cup part has a negative pressure. Due to this, the frame member 45 is sucked by the suction cup part of the holder 502 and is held by keeping this. The holder 502 holds the uppermost frame member 45 among the stacked frame members 45. The robot arm 501 is operated to place the held frame member 45 on the current collector 31B. The frame member 45 is placed on the current collector 31B so as to extend the thickness direction of the frame member 45 along the vertical direction. In a state where the valve is switched so that the air in the internal space of the degassing pipe 503 is not discharged, the holder 502 is separated from the frame member 45 placed on the current collector 31B. The frame member 45 placed on the current collector 31B is conveyed to the downstream side D1 together with the current collector 31B. For example, the frame member 45 is arranged on the current collector 31B along the conveying direction D without any gap.

As shown in FIG. 3, the first roll press 600 comprises a pair of compression rollers 601 and a drive part 602. The pair of compression rollers 601 are arranged in a way that their respective axes extend along the horizontal plane. The pair of compression rollers 601 are arranged to face each other vertically. The drive part 602 rotates the pair of compression rollers 601 around their respective axes. The current collector 31B and the frame member 45 are sandwiched between the pair of compression rollers 601. The drive part 602 rotates the pair of compression rollers 601 so as to convey the current collector 31B and the frame member 45 to the downstream side D1.

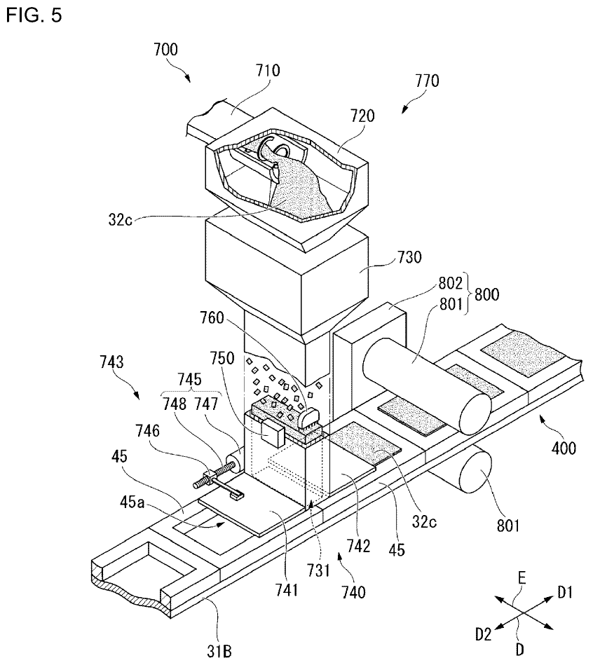

The active material supply device 700 supplies the powdery active material 32c onto the current collector 31B that is conveyed in the first chamber 100. The active material 32c means a plurality of electrode granulated particles containing an electrode active material and a conductive auxiliary agent. As shown in FIG. 5, the active material supply device 700 comprises a screw conveyor 710, an input chute 720, an output chute 730, a shutter unit 740, an ultrasonic vibrator 750, and a leveling brush 760. Herein, a hopper 770 is composed of the input chute 720 and the output chute 730. The hopper 770 is arranged in the first chamber 100. The frame member supply device 500 is arranged upstream side D2 from the hopper 770. In other words, after supplying the frame member 45 onto the current collector 31B, the active material 32c is supplied onto the current collector 31B. The screw conveyor 710 throws the active material 32c into the input chute 720. The one end of the screw conveyor 710 is connected to a reservoir or the like (not shown in the figure), which is arranged outside the first chamber 100, for the active material 32c. The other end of screw conveyor 710 is connected to input chute 720.

The input chute 720 drops the active material 32c, which is conveyed from the screw conveyor 710, into the output chute 730. In other words, the hopper 770 contains the active material 32c. The output chute 730 has a tubular shape extending along the vertical direction. An opening 731 is formed at the lower end of the output chute 730. The output chute 730 is arranged below the input chute 720. The opening 731 is formed at the lower end of the hopper 770. The opening 731 is formed along the horizontal plane. The hopper 770 is arranged above the conveying device 400. In other words, the hopper 770 is arranged above the current collector 31B and the frame member 45 that are conveyed by the conveying device 400. The opening 731 supplies the active material 32c onto the current collector 31B arranged in the first chamber 100 (toward the current collector 31B). The active material 32c, which is conveyed from the screw conveyor 710 into the input chute 720, freely falls into the output chute 730. The active material 32c is contained in the hopper 770. Herein, in a state where the active material 32c is clumped on the screw conveyor 710, the active material supply device 700 may comprise a crusher for crushing the clumped active material 32c.

The shutter unit 740 comprises a first shutter door (shutter) 741, a second shutter door (shutter) 742, a first opening/closing mechanism (opening/closing mechanism) 743, and a second opening/closing mechanism (opening/closing mechanism) 744. The shutter doors 741 and 742 are flat-shaped respectively. The shutter doors 741 and 742 are arranged along the horizontal plane. The second shutter door 742 is arranged downstream side D1 from the first shutter door 741. The shutter doors 741, 742 open and close the opening 731 of the output chute 730. Herein, the state wherein the shutter doors 741, 742 open the opening 731 implies that the shutter doors 741, 742 do not cover at least part of the opening 731. The state wherein the shutter doors 741, 742 close the opening 731 implies that the shutter doors 741, 742 completely block the opening 731.

The first opening/closing mechanism 743 comprises a motor 745 and an arm 746. In the motor 745, the rotating shaft 748 facing the main body 747, rotates around the axis of the rotating shaft 748. A male screw is formed on the outer peripheral surface of the rotating shaft 748. The motor 745 is arranged such that the rotating shaft 748 can extend along the conveying direction D. The main body 747 is fixed to the floor of the first chamber 100 or the like. A female screw (not shown in the figure) is formed at the first end of the arm 746. This female screw engages with the male screw of the rotating shaft 748 of the motor 745. A second end opposite to the first end of the arm 746 is fixed to the upper surface of the first shutter door 741.

As for the first shutter door 741 and the first opening/closing mechanism 743 configured as described above, for example, in a case when a voltage with a predetermined direction is applied to the motor 745, the rotating shaft 748 starts to rotate along a predetermined direction. The first shutter door 741 connected to the rotating shaft 748 via the arm 746, moves to the downstream D1. Similarly, in a case when a voltage with an opposite direction from the predetermined direction is applied to the motor 745, the rotating shaft 748 starts to rotate along the direction opposite from the predetermined direction. The first shutter door 741 moves to the upstream side D2. Thus, the first opening/closing mechanism 743 conveys the first shutter door 741 to the conveying direction D. The second opening/closing mechanism is configured similarly to the first opening/closing mechanism 743. With the second opening/closing mechanism, the second shutter door 742, which is independent from the first shutter door 741, can be moved to the downstream side D1 and the upstream side D2.

The ultrasonic vibrator 750 is equipped on the outer wall of the lower side of the output chute 730. In other words, the ultrasonic vibrator 750 is equipped outside the portion of the output chute 730, wherein the active material 32c is deposited around at the level of said portion. The ultrasonic vibrator 750 vibrates the active material 32c deposited in the lower part of the output chute 730 by generating ultrasonic waves. The ultrasonic vibrator 750 has a role to make the active material 32c uniformed, wherein the active material 32c is deposited in the output chute 730.

The leveling brush 760 moves horizontally by a motor (not shown in the figure). The leveling brush 760 serves to level the upper surface of the active material 32c deposited in the output chute 730. As described above, in this embodiment, a part of the active material supply device 700 having the opening 731 is arranged in the first chamber 100. Herein, it is noted that at least the opening 731 of the active material supply device 700 is arranged in the first chamber 100. The entire active material supply device 700 may be arranged in the first chamber 100.

The active material supply device 700 is controlled to open the shutter doors 741, 742 only when the internal space 45a of frame member 45 is positioned under the opening 731. With this configuration, the active material 32c, which is supplied from the opening 731, is arranged in the internal space 45a (inside the frame member 45) of the frame member 45 with a first thickness on the current collector 31B. Thus, the active material supply device 700 supplies the active material 32c into the frame member 45 arranged on the current collector 31B. For example, the first thickness is thicker than the thickness of the frame member 45. In order to adjust the opening timing of the shutter doors 741, 742 according to the passing timing of the internal space 45a of the frame member 45 arranged under the opening 731, the general timing control based on the conveying speed of the conveying device 400, the length of the frame member 45 along the conveying direction D and the like are used. It is noted that the manufacturing device 1000 may comprise a position sensor that detects the position of the frame member 45 along the conveying direction D. Then, based on the position of the frame member 45 detected by the position sensor, the control unit 900 may adjust the opening timing of the shutter doors 741, 742 by the first opening/closing mechanism 743 and the second opening/closing mechanism. The opening/closing control of the shutter doors 741, 742 will be described below.

The second roll press 800 compresses the active material 32c supplied onto the current collector 31B. The second roll press 800 is configured similarly to the first roll press 600. The second roll press 800 comprises a pair of compression rollers 801 and a drive part 802. Between the pair of compression rollers 801, the current collector 31B, the frame member 45, and the active material 32c are sandwiched. The second roll press 800 compresses the active material 32c having the first thickness to a second thickness that is less than the first thickness. For example, the second thickness is equal to the thickness of the frame member 45. It is noted that the configurations of the first roll press 600 and the second roll press 800 are not limited to these.

The control unit 900 has a CPU (Central Processing Unit) (not shown in the figure) and a memory. The memory stores a control program for operating the CPU, various data, and the like. The control unit 900 is connected to the first opening/closing mechanism 743, the second opening/closing mechanism, and the like. The control unit 900 controls the first opening/closing mechanism 743, the second opening/closing mechanism 744, and the like.

In the manufacturing method of the present embodiment, first, the frame member 45 is supplied onto the current collector 31B arranged in the first chamber 100 whose interior is decompressed below atmospheric pressure. The active material 32c is supplied to the internal space (inside) 45a of the frame member 45 on the current collector 31B. In other words, the supply of the frame member 45 is conducted in the upstream side D2 from the location where the active material 32c is supplied onto the current collector 31B. Then, the active material 32c supplied into the internal space 45a of the frame member 45 on the current collector 31B is compressed. The supply of the frame member 45 onto the current collector 31B, the supply of the active material 32c to the current collector 31B, and the compression of the active material 32c are performed in the first chamber 100.

The electrode 30 is manufactured by appropriately cutting out the current collector 31 from the strip-shaped current collector 31B. A single cell 20 is manufactured by stacking a pair of electrodes 30 (that is, a cathode 30a and an anode 30b) while the pair of electrodes 30 faces each other via a separator 40, which is interposed therebetween. The battery 10 is manufactured by stacking a plurality of single cells 20 along the thickness direction and by sealing the plurality of single cells 20 with the exterior body 12. Also, in a case when sealing the plurality of single cells 20 with the exterior body 12, the expansion of the air contained in the active material 32c is suppressed.

As described above, according to the manufacturing device 1000 of the present embodiment, the active material supply device 700 and the second roll press 800 are arranged in the first chamber 100 whose interior is decompressed below atmospheric pressure. Therefore, in a case when the active material 32c is supplied onto the current collector 31B and in a case when the active material 32c supplied onto the current collector 31B is compressed, the air is less likely to be contained in the active material 32c. Therefore, in a case when compressing the active material 32c, the air contained in the active material 32c is suppressed. It is possible to improve the uniformity of the active material 32c formed on the current collector 31B. Further, according to the manufacturing method of the present embodiment, in a case when the active material 32c is supplied onto the current collector 31B and in a case when the active material 32c supplied onto the current collector 31B is compressed, the air is less likely to be contained in the active material 32c. Therefore, in a case when compressing the active material 32c, the air contained in the active material 32c is suppressed. It is possible to improve the uniformity of the active material 32c formed on the current collector 31B. In the manufacturing device 1000 and the manufacturing method of the present embodiment, the active material 32c, which is supplied onto the current collector 31B, is roll-pressed without using a binder. Therefore, there is an advantage that powder does not fly in the first chamber 100.

The manufacturing device 1000 comprises the frame member supply device 500 arranged in the first chamber 100. In the manufacturing method, the frame member 45 is supplied on the current collector 31B in the first chamber 100. As a result, the active material 32c can be contained in the internal space 45a of the frame member 45, and it is possible to prevent the active material 32c from spilling over the current collector 31B. The frame member supply device 500 is arranged in the upstream side D2 from the active material supply device 700, and the active material 32c supplied onto the current collector 31B is supplied into the internal space 45a of the frame member 45. In the manufacturing method, the supply of the frame member 45 is performed in the upstream side D2 from the supply of the active material 32c onto the current collector 31B. The active material 32c is supplied into the internal space 45a of the frame member 45, and the active material 32c is compressed. With these configurations, the active material 32c supplied into the internal space 45a of the frame member 45 can be compressed in order to prevent the active material 32c from spilling over the current collector 31B.

It is possible for the active material 32c having the first thickness, which is arranged on the current collector 31B, to be compressed by the second roll press 800, wherein the active material 32c has the second thickness that is thinner than the first thickness. The manufacturing device 1000 comprises the second chamber 200 and the current collector supply device 300, arranged within the second chamber 200. Thus, the current collector 31B, on which the active material 32c is arranged, is exposed in advance to an environment whose pressure is decompressed below the atmospheric pressure in the second chamber 200. As a result, it is possible to suppress the active material 32c from containing air through the current collector 31B. It is possible to suppress air from entering the first chamber 100 from the current collector supply device 300.

The current collector supply unit 300 continuously supplies the current collector 31B into the first chamber 100 by bonding ends of the strip-shaped current collector 31B. Therefore, the current collector 31B can be continuously supplied into the first chamber 100. The pressure in the second chamber 200 is higher than the pressure in the first chamber 100. Therefore, compared to the case where the internal pressure of the second chamber 200 is equal to the internal pressure of the first chamber 100, the power required to decompress the second chamber 200 can be reduced.

As described above, the first embodiment and the second embodiment of the present invention have been described in detail with reference to the drawings. However, the present invention is not limited to the above-described embodiments and includes various modifications, combinations and deletions within the scope of the present invention. For example, in the above embodiments, the pressure in the second chamber 200 may be equal to the pressure in the first chamber 100. The current collector supply device 300 may not have the splicer 310. In this case, the ends of the current collector 31B are not bonded. The frame member supply device 500 may be arranged in the downstream side D1 from the active material supply device 700. In this case, the frame member 45 may be supplied onto the current collector 31B after the active material 32c is supplied onto the current collector 31B. The manufacturing device 1000 does not have to comprise the second chamber 200, the current collector supply device 300, the conveying device 400, the frame member supply device 500, the first roll press 600 and the control unit 900. In this case, in the corresponding manufacturing method, the step of supplying the frame member 45 onto the current collector 31B and the step of supplying the active material 32c into the internal space 45a of the frame member 45, are not performed.

### INDUSTRIAL APPLICABILITY

The present invention can be applied to manufacture battery electrodes.

### REFERENCE SIGNS LIST

31B current collector
32c active material
45 frame member
100 first chamber
200 second chamber
300 current collector supply device (current collector supply unit)
500 frame member supply device (frame member supply unit)
700 active material supply device (active material supply unit)
800 second roll press (compressor)
1000 manufacturing device (battery electrode manufacturing device)
D2 upstream side

1. A battery electrode manufacturing device comprising:
a first chamber whose interior is decompressed below atmospheric pressure;
an active material supply unit that supplies a powdery active material onto a current collector, which is arranged in the first chamber; and
a compressor that compresses the active material supplied on the current collector,
wherein the active material supply unit and the compressor are arranged in the first chamber.

2. The battery electrode manufacturing device according to claim 1, further comprising:
a frame member supply unit that supplies a circular frame member on the current collector,
wherein the frame member supply unit is arranged in the first chamber.

3. The battery electrode manufacturing device according to claim 2,
wherein the frame member supply unit is arranged in an upstream side from the active material supply unit, and
wherein the active material, which is supplied onto the current collector, is supplied in the frame member.

4. The battery electrode manufacturing device according to claim 1,
wherein the current collector is supplied at a predetermined speed in the first chamber,
wherein the active material, which is supplied from the active material supply unit, is arranged onto the current collector with a first thickness, and
wherein the compressor compresses the active material from the first thickness to a second thickness that is less than the first thickness.

5. The battery electrode manufacturing device according to claim 1, further comprising:
a second chamber whose interior is decompressed below atmospheric pressure and arranged side by side with the first chamber; and
a current collector supply unit that is at least partially arranged in the second chamber, and that supplies the current collector into the first chamber.

6. The battery electrode manufacturing device according to claim 5,
wherein the current collector supply unit continuously supplies the current collector into the first chamber by bonding ends of the strip-shaped current collector.

7. The battery electrode manufacturing device according to claim 5,
wherein a pressure in the second chamber is higher than a pressure in the first chamber.

8. A method of manufacturing a battery electrode, the method comprising:
a supply step of supplying a powdery active material onto a current collector, which is arranged in a first chamber whose interior is decompressed below atmospheric pressure; and
a compressing step of compressing the active material supplied on the current collector,
wherein the supply step and the compressing step are conducted in the first chamber.

9. The method of manufacturing a battery electrode according to claim 8, further comprising:
a frame member supply step of supplying a circular frame member onto the current collector,
wherein the frame member is supplied in the first chamber.

10. The method of manufacturing a battery electrode according to claim 9,
wherein the frame member supply step is conducted in an upstream side from the supply of the active material onto the current collector,
wherein the active material is supplied in an internal space of the frame member, and
wherein the active material, which has supplied in the internal space of the frame member, is compressed.
